(19) United States
(12) Patent Application Publication
(10) Pub. No.: US 2011/0272228 A1
(43) Pub. Date: Nov. 10, 2011

(54) BRAKE SYSTEM FOR A MOTOR VEHICLE AND MOTOR VEHICLE HAVING SUCH A BRAKE SYSTEM

(76) Inventors: Michael Kunz, Steinheim An Der Murr (DE); Matthias Leiblein, Gerlingen (DE); Werner Quirant, Beilstein (DE); Jens Kolarsky, Bietigheim/Bissingen (DE)

(21) Appl. No.: 13/130,435

(22) PCT Filed: Oct. 16, 2009
(86) PCT No.: PCT/EP2009/063576

§ 371 Date: Jul. 21, 2011

(30) Foreign Application Priority Data
Nov. 24, 2008 (DE) 1020080440027

(51) Int. Cl. B60T 13/132; B60T 8/40; B60T 8/176; B60T 13/16

(52) U.S. Cl. 188/358; 188/361; 303/113.1

(57) ABSTRACT

A brake system for a motor vehicle having an at least single-circuit brake cylinder with the aid of which a brake force may be applied to at least one wheel of the motor vehicle when actuated. The brake cylinder is mechanically operatively connected to a booster cylinder, which is decoupled from brake setpoint detector and is hydraulically triggerable for actuation of the brake cylinder corresponding to the driver's intent as detected with the aid of the brake setpoint detector. A motor vehicle having a brake system is also described.

### FIELD OF THE INVENTION

The present invention relates to a brake system for a motor vehicle, having an at least single-circuit brake cylinder with the aid of which a brake force may be applied to at least one wheel of the motor vehicle when actuated. The present invention also relates to a motor vehicle having a brake system.

### BACKGROUND INFORMATION

German Patent Application No. DE 10 2005 039 314 A1 describes a method and a device for recuperation of energy during a braking operation of a hybrid vehicle. For this purpose, a brake system is provided, which is connected to a brake booster, having a brake cylinder via a brake pedal, a brake fluid container being situated on the brake cylinder. The brake booster boosts the brake force exerted by the driver on the brake pedal and generates a brake pressure, which is directed to wheel brakes via brake lines. The device described here takes into account the particular feature of hybrid vehicles, namely the recuperation of braking energy through recuperative braking. In this method, an electric motor, usually the electric drive motor of the motor vehicle, is operated as a generator. The electrical energy thereby generated is fed into an energy storage. The energy stored there may be retrieved as needed, for example, for operation of the drive motor and/or for a vehicle electrical system of the motor vehicle. The power loss by the motor vehicle during braking is reduced due to this recuperation. This is therefore a measure for reducing fuel consumption and emissions. Recuperative braking makes high demands on the conventional friction-based brake system of the motor vehicle because the braking effect based on recuperation depends on multiple factors. Initially, the recuperative brake is not available when the (electrical) energy storage is full. This means that in this case, the total braking torque must be applied to the wheels by the conventional brake, i.e., friction brakes, for example. In addition, the recuperative brake system does not allow braking torques until the motor vehicle comes to a standstill via the electric motor, which is operated as a generator. During stoppage of the motor vehicle, the conventional brake system must therefore compensate in the low-speed range for the loss of braking effect of the recuperative brake by supplying a higher braking torque. There are also operating states in which the hydraulic brake force must be reduced to achieve a high degree of recuperation. For example, after shifting operations, the decoupled generator is blended in as a recuperative brake via clutch engagement to shift the braking effect back in the direction of the recuperative brake. To keep the total braking torque constant

which is generated jointly by the conventional and recuperative brake systems—the proportion of the conventional friction brake must therefore be reduced. The two procedures explained above are referred to as “blending.” In designing the brake system, it is taken into account the premise that use of the recuperative brake system should not have any effect on the braking distance.

In simple brake systems, a driver of a motor vehicle assumes the task of the deceleration regulator. The driver thus manually corrects the braking torque when the energy storage is full, for example, and/or at low speeds. When the recuperative braking torque is unavailable or added, the driver adjusts the conventional brake system via the pedal to achieve the intended deceleration. The pedal modulations are reasonable but are not optimal from the standpoint of comfort, in particular at low recuperative braking torques. Since almost no additional effort is required for such a brake system in comparison with conventional brake systems, this approach is optimal from a cost standpoint. If higher demands are to be met, then brake-by-wire brake systems (for example, EHB systems) may be used, for example. These decouple the brake pedal from the rest of the brake system. Due to this decoupling, the braking torques of the conventional brake system and the recuperative brake system may be blended in almost any way, whereas the blending operations may be performed without being noticed by the driver. This approach constitutes an optimal approach from the standpoint of comfort but is also very cost-intensive.

### SUMMARY

An example brake system in accordance with the present invention may have the advantage that it may be implemented very inexpensively but at the same time permits very high degrees of recuperation. Components may also be taken over from conventional brake systems. This is achieved according to the present invention by mechanically operatively connecting the brake cylinder to a booster cylinder, which is decoupled from a brake setpoint detection means, the booster cylinder being hydraulically triggerable for actuation of the brake cylinder according to a driver's intent detected with the aid of the brake setpoint detection means. The brake cylinder of the brake system has at least a single circuit. It may thus be provided that the brake force may be applied to one or more wheels of the motor vehicle with the aid of the brake cylinder. A multi-circuit brake cylinder may also be provided, for example, with one circuit being assigned to a front axle and another to a rear axle of the motor vehicle or one circuit being assigned to a front wheel and another to a rear wheel. The brake cylinder supplies the brake pressure for the wheel or wheels. Thus, there is at least one piston in the brake cylinder for generating the brake pressure. For this purpose, the brake cylinder or a piston situated therein is mechanically operatively connected to the booster cylinder. This means that the piston of the brake cylinder is connected to a piston of the booster cylinder. At the same time, the brake cylinder is mechanically decoupled from the brake setpoint detector. The brake setpoint detector may include or be connected to the brake pedal, for example. The brake cylinder is thus not acted upon directly by the brake setpoint detector. It may also be provided that no direct connection exists between the brake setpoint detector and the booster cylinder. The booster cylinder is instead triggered hydraulically. This takes place in accordance with the driver's intent, which is detectable with the aid of the brake setpoint detector. Additional braking torques applied by a generator, for example, may be taken into account in the hydraulic brake pressure. In the example brake system according to the present invention, essential components from a conventional brake system may be used. These components may include, for example, the brake cylinder or an ESP unit and/or an ABS unit. The driver of the motor vehicle may be completely decoupled from the brake system through the design of the example brake system according to the present invention, i.e., there is no mechanical feedback of the brake system via the brake setpoint detector. However, such feedback is easily implementable, as will be explained further below. The brake system described here may be provided not only in motor vehicles having a hybrid drive but also in those having a conventional drive. This offers various advantages. Initially, all fully active pressure build-ups of conventional brake systems may be exhibited almost soundlessly with the highest pressure dynamics and pressure adjustment precision. Likewise, comfort functions, for example, a deceleration regulation for ACC (adaptive cruise control) systems, may also be exhibited very well up to the vehicle standstill. Due to the decoupling of the driver, no feedback effects are perceptible via the brake setpoint detector, for example, including the brake pedal. If the brake pressure required for actuation of the booster cylinder is designed to be decoupled over time, for example, through temporary storage of the brake pressure generated by a pump in a pressure storage, then the actuation of the brake system or a deceleration regulation may take place soundlessly. The dynamics achievable with the brake system according to the present invention fulfill the highest demands for all ACC-related functions, for example, ACC stop and go, parking assistant, and others. Since motor vehicles having a hybrid drive often represent only a small portion of a vehicle platform, extensive compatibility between the brake system and the motor vehicle having the conventional drive and that having the hybrid variant is advantageous.

One refinement of the present invention provides that the brake setpoint detector is a sensing cylinder operatively connected to a brake pedal and/or a displacement sensor system, which senses a deflection of the brake pedal. The driver of the motor vehicle thus has an opportunity to signal his braking intent to the brake system via the brake pedal. The deflection of the brake pedal may be detected with the aid of the sensing cylinder or the displacement sensor system.

One refinement of the present invention provides a hydraulic system, which is provided for triggering the booster cylinder. The hydraulic triggering of the booster cylinder thus takes place through the hydraulic system in which or with the aid of which a brake pressure may be built up.

One refinement of the present invention provides that the hydraulic system has a pump for generating a pressure and/or a pressure storage for storing the pressure and/or a pressure sensor for determining the pressure. The hydraulic system provided for triggering the booster cylinder thus has a pump, for example, a hydraulic pump, which generates the brake pressure in the system. The pressure generated may be stored temporarily in a pressure storage until it is needed for actuation of the booster cylinder. In this way, generation of pressure and triggering of the booster cylinder may be decoupled over time. The brake system is therefore able to operate very quietly, preferably almost soundlessly, because the pressure from the pressure storage may be used to trigger the booster cylinder and thus to actuate the brake cylinder when the driver intends to brake. In addition, the pressure sensor with the aid of which the pressure generated by the pump and/or the pressure in the pressure storage may be sensed is preferably also provided. Based on the data from the pressure sensor, the pump and the pressure storage may thus be controlled and/or regulated. For example, the pressure in the hydraulic system may always be kept constant, at least while the booster cylinder is not being triggered.

One refinement of the present invention provides that the sensing cylinder is provided for feedback of brake force information, generated with the aid of a brake force simulation unit, to the driver. Regardless of whether the deflection of the brake pedal is detected with the aid of the sensing cylinder or the displacement sensor system, the sensing cylinder is able to provide the driver with feedback concerning the brake force information. In this way, reliable and unambiguous feedback to the driver may be accomplished.

For example, this information may be proportional to the braking torque or the brake force actually applied to the wheel of the motor vehicle or may follow any function distribution. The brake force simulation unit is provided to generate the brake force information, which is relayed to the driver via the sensing cylinder. This unit generates a pressure, for example, or it presents a resistance, which is relayed via the sensing cylinder to the brake setpoint detector, and thus the brake force information is made available to the driver. Likewise, however, it is possible to provide that the brake force simulation unit influences the brake setpoint detection means directly, for example, via a control circuit.

One refinement of the present invention provides that a pressure build-up valve, which is switchable to build up pressure in the booster cylinder, is provided between the pump and/or the pressure storage and the booster cylinder. The pressure generated by the pump or stored in the pressure storage may be conveyed to the booster cylinder with the aid of the pressure build-up valve in a targeted manner. When the pressure build-up valve is switched, fluid is able to enter the booster cylinder and the pressure is allowed to build up there. When the pressure build-up valve is not switched, the booster cylinder is thus decoupled from the pump and/or the pressure storage, so that the pressure in the booster cylinder cannot build up further and thus remains constant and/or declines. Thus, when the pressure build-up valve is switched, the brake cylinder is actuated via the booster cylinder, and thus the brake force is applied to the at least one wheel of the motor vehicle. The pressure build-up valve may be used together with the pressure storage in a particularly advantageous manner because in this way it is possible to turn off the pump as long as the pressure in the pressure storage is adequate.

One refinement of the present invention provides that a switchable pressure reducing valve is provided for reducing the pressure in the booster cylinder. Similarly to the pressure build-up valve, with the aid of which the pressure in the booster cylinder may be built up, the pressure may be reduced with the aid of the pressure reducing valve. If the pressure reducing valve is switched, the brake force applied to the at least one wheel of the motor vehicle is thus reduced. The hydraulic pressure in the booster cylinder may thus be reduced via the pressure reducing valve, so that fluid leaves the booster cylinder. The hydraulic medium used is advantageously supplied to a storage (pressure equalizer) and/or to the pump.

One refinement of the present invention provides that the brake force simulation unit is a brake force simulation cylinder acted upon by a spring. The brake force simulation cylinder functions to represent the intended characteristic of the brake setpoint detector, for example, a pedal travel and/or a pedal force. For example, when the sensing cylinder is actuated, volume may be displaced from this to the brake force simulation cylinder. This volume counteracts the spring force, so that feedback concerning the sensing cylinder—via the pressure built up in this cylinder—is conveyed to the driver of the motor vehicle. The brake force simulation cylinder may also be acted upon in some other way, for example, via a valve which adjusts the pressure in the brake force simulation cylinder in a controlling or regulating manner. Thus, there may only be a spring action of the brake force simulation cylinder induced by hydraulic pressure.

One refinement of the present invention provides that the brake force simulation unit has a deactivation valve for locking the brake force simulation unit. By using the deactivation valve, it is possible to prevent the brake force simulation unit from generating the brake force information. For example, the brake force simulation cylinder may be locked. At that point, no additional fluid may flow out of the sensing cylinder into the brake force simulation cylinder or out of the latter. In order for the brake force simulation unit to be able to represent the intended characteristic (pedal force and/or pedal travel), the deactivation valve does not have to be actuated, so it does not have to lock the brake force simulation unit. For example, the deactivation valve may be opened when a braking intent is detected; in other words, it is not actuated, or alternatively, it may also be opened continuously after switched ignition of the motor vehicle. Other strategies are also possible. The deactivation valve is used to improve the volume balance (and thus in particular to improve the brake force information for the driver) if the brake system fails because then (brake) fluid cannot enter the brake force simulation unit. Care must thus be taken to ensure that the deactivation valve locks the brake force simulation unit in the event of an error in the brake system or a failure thereof. A currentless position of the deactivation valve must be provided accordingly.

One refinement of the present invention provides that the deactivation valve is operatively connected to the sensing cylinder either directly or via the brake force simulation unit. The deactivation valve may thus be provided between the sensing cylinder and the brake force simulation unit. Alternatively, it is also possible to connect the brake force simulation unit to the sensing cylinder on the one hand and to the deactivation valve on the other hand. In the latter case, the brake force simulation unit is acted upon by the sensing cylinder on the one hand as soon as the driver actuates the brake setpoint detector. At the same time, the deactivation valve prevents fluid from flowing out of the brake force simulation unit on the other hand. In this way, the brake force simulation unit cannot be actuated, i.e., it is locked.

One refinement of the present invention provides that a pressure equalizer of the hydraulic system is provided. Via the pressure equalizer it is possible to ensure that a sufficient quantity of the fluid/hydraulic medium is always present in the brake system, i.e., the hydraulic system. The pressure equalizer may be provided, for example, as a hydraulic fluid container or as a brake fluid container. If there is a pump in the hydraulic system, it will advantageously withdraw the hydraulic fluid from the pressure equalizer.

One refinement of the present invention provides that the booster cylinder is hydraulically and/or mechanically coupled to the sensing cylinder. Therefore, it is not necessary for the booster cylinder to be triggered merely via the pressure build-up valve or the pressure reducing valve. It is likewise possible to provide for the booster cylinder to be hydraulically coupled to the sensing cylinder, so that actuation of the brake setpoint detector results in deflection of the booster cylinder. Likewise, there may be a mechanical link to the sensing cylinder. This is ideally provided in addition to the hydraulic connection. Via the mechanical coupling of the sensing cylinder to the booster cylinder, it is possible to achieve the result that actuation of the brake system is possible even with a pressure drop in the hydraulic system. In this case, the driver's intent is mechanically transferred from the sensing cylinder to the booster cylinder, which is itself mechanically operatively connected to the brake cylinder. In this case, actuation of the brake cylinder based on the driver's intent is possible even in the event of a failure of the hydraulic system. It is provided here that the sensing cylinder is not coupled mechanically to the booster cylinder immediately after actuation but instead a free-wheeling zone is provided in which the actuation of the sensing cylinder has no effect. This free-wheeling zone is necessary to ensure the blendability of the brake system.

One refinement of the present invention provides that a pressure sensor is operatively connected to the sensing cylinder. For example, the driver's intent detected via the brake setpoint detector may be analyzed with the aid of the pressure sensor. Thus, the pressure in the sensing cylinder is detected.

One refinement of the present invention provides that the pressure storage has a decoupling valve for decoupling of additional elements of the hydraulic system. The pressure storage may be completely closed via the decoupling valve. In this way, the pressure in the pressure storage cannot be built up further and also cannot be reduced. In this way, the pressure drop in the hydraulic system due to leakage—of the valves, for example—may be minimized. As soon as the pressure in the pressure storage has been built up, the latter is decoupled via the decoupling valve, so that the high pressure need not be maintained in the entire hydraulic system. The pressure storage is coupled back into the hydraulic system, so that the booster cylinder may be hydraulically actuated only as needed, i.e., on detection of a driver's intent with the aid of the brake setpoint detector. Likewise, by preventing a further build-up of pressure in the pressure storage, it is possible to prevent a pressure in the system for pressure build-up from being lost in the pressure storage. Thus, the pump may build up very high pressures in the hydraulic system in a very short period of time. These pressures may be built up in the booster cylinder and thus a high brake force may be applied to the at least one wheel of the motor vehicle via the brake cylinder. In this way, very high brake forces, which may be necessary, for example, for functions for preventing a rollover of the motor vehicle, may be built up within a very short period of time.

One refinement of the present invention provides that the brake cylinder is operatively connected to a brake device of the wheel. On actuation of the brake cylinder the brake force may be applied to the wheel of the motor vehicle via the brake device. The brake device may be, for example, a wheel brake caliper having the corresponding hydraulic cylinder.

One refinement of the present invention provides that at least one modulation unit, in particular an ABS or ESP unit, is provided between the brake cylinder and the brake device. The pressure built up in the brake cylinder, which is used for applying the brake force to the wheel of the motor vehicle (with the aid of the brake device), is thus directed into the modulation unit before reaching the brake device. The pressure prevailing in the modulation unit may be varied, in particular reduced. Such measures are often used to stabilize the motor vehicle as part of an ABS or ESP system. For example, it is possible to prevent locking of the wheel of the motor vehicle with the aid of the modulation unit, even though the motor vehicle is in motion, and if the motor vehicle has a plurality of wheels influenced by the brake system, individual wheels may also be influenced.

One refinement of the present invention provides that the motor vehicle has a conventional drive or a hybrid drive. The brake system may thus be used equally for motor vehicles having a conventional drive or a hybrid drive.

The present invention also includes a motor vehicle having a brake system, which is designed according to the preceding embodiments. The motor vehicle may optionally be equipped with a conventional drive or a hybrid drive. The brake system of the motor vehicle may of course be refined according to individual features described above.

The present invention is explained in greater detail below on the basis of the exemplary embodiments depicted in the figures, without the present invention being restricted thereto.

### BRIEF DESCRIPTION OF THE DRAWINGS

FIG. 1 shows a brake system having a two-circuit brake cylinder, which has a deactivation valve for locking a brake force simulation unit and a connecting valve between a sensing cylinder and a booster cylinder.

FIG. 2 shows the brake system of FIG. 1, a decoupling valve being provided for decoupling a pressure storage.

FIG. 3 shows the brake system, in which the deactivation valve and the connecting valve are both omitted.

FIG. 4 shows the brake system, in which the deactivation valve is operatively connected directly to the sensing cylinder.

FIG. 5 shows the brake system, in which a brake cylinder having only one circuit is provided.

FIG. 6 shows the brake system, in which the deactivation valve is situated upstream from the brake force simulation unit.

### DETAILED DESCRIPTION OF EXAMPLE EMBODIMENTS

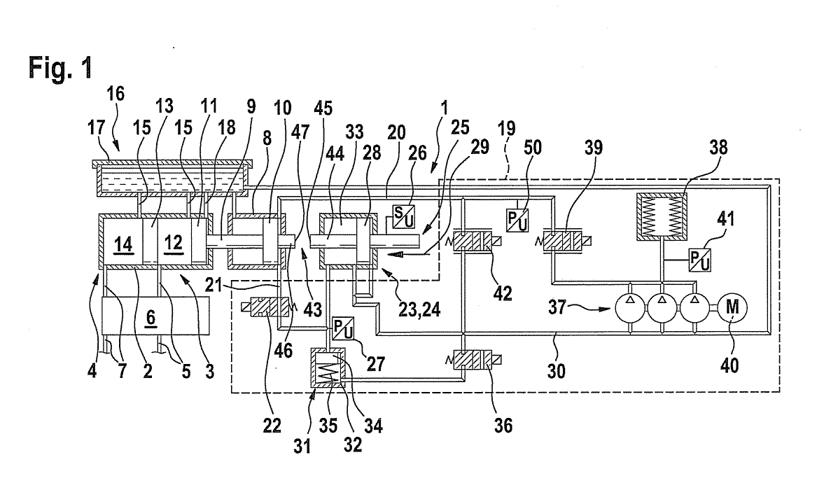

FIG. 1 shows a brake system 1 having a two-circuit brake cylinder 2, which has a first brake circuit 3 and a second brake circuit 4. First brake circuit 3 is connected via a brake line 5 to a modulation unit 6, which modulates the pressure prevailing in first brake circuit 3, for example, within the scope of an ABS or ESP method. First brake circuit 3 is connected to brake devices (not shown) at the output side of modulation unit 6. The brake devices of first brake circuit 3 are used, for example, for applying a brake force to wheels (not shown) on a front axle (not shown) of a motor vehicle (also not shown), in which brake system 1 is provided. Likewise, second brake circuit 4 is connected via a brake line 7 to modulation unit 6, brake devices being provided at the output side of modulation unit 6, so that these brake devices are able to apply a brake force to wheels on the rear axle of the motor vehicle. Modulation unit 6 is able to modulate the pressure for individual wheels of the motor vehicle. Brake system 1 also has a booster cylinder 8, which is mechanically operatively connected to brake cylinder 2. A mechanical connection via a rod 9, which connects a piston 10 of booster cylinder 8 to a piston 11 of brake cylinder 2, is provided for this purpose. During a deflection of piston 10 in booster cylinder 8, piston 11 is also deflected in cylinder 2. Therefore, a pressure may be built up during a movement of piston 10 in a chamber 12 of brake cylinder 2 and then applied in modulation unit 6 via brake line 5. Likewise, another piston 13 of brake cylinder 2, which is assigned to second brake circuit 4, is also moved by the pressure in chamber 12. Pressure is thus also built up in another chamber 14 and supplied to modulation unit 6 via brake line 7 of second brake circuit 4. Chambers 12 and 14 are in fluid connection to a pressure equalizer 16, which is designed as a brake fluid container 17, via lines 15 in the undeflected state of pistons 11 and 13. To enable a deflection of piston 11, another line 18 is provided which opens into brake cylinder 2 on a side of piston 11 facing away from chamber 12. In this way, brake fluid from brake fluid container 17 is able to go into a chamber formed by the movement of piston 11.

Booster cylinder 8 is actuated by a hydraulic system 19. For this purpose, it is connected to a high-pressure line 20 and a connecting line 21. Connecting line 21 establishes a fluid connection between booster cylinder 8 and a sensing cylinder 23 via a connecting valve 22. Sensing cylinder 23 is used as brake setpoint detector 24, i.e., it detects a driver's intent according to a braking activity. Sensing cylinder 23 has a mechanical connection 25 to a brake pedal (not shown) of the motor vehicle.

A displacement sensor system 26, with the aid of which a deflection of the brake pedal is detectable, may also be connected to mechanical connection 25. Alternatively or additionally, the deflection of sensing cylinder 23 may be determined with the aid of a pressure sensor 27, which measures a pressure resulting due to a deflection of a piston 28 in sensing cylinder 23. Pressure sensor 27 may be provided in connecting line 21, preferably between connecting valve 22 and sensing cylinder 23. Thus a pedal force, represented by arrow 29, on the brake pedal may be determined with the aid of displacement sensor system 26 or pressure sensor 27. This pedal force reflects the driver's intent. To enable a movement of piston 28, sensing cylinder 23 is in fluid connection with a low-pressure line 30.

Brake system 1 also has a brake force simulation unit 31, which is designed as a brake force simulation cylinder 32. Brake force simulation cylinder 32 is connected on one side to connecting line 21, for example, preferably in the same way as pressure sensor 27 is connected between connecting valve 22 and sensing cylinder 23. On actuation of sensing cylinder 23, i.e., the deflection of piston 28, hydraulic fluid may be forced out of a chamber 33 of sensing cylinder 23 into brake force simulation cylinder 32. Therefore, a piston 34 in brake force simulation cylinder 32 may be deflected. This is counteracted by a spring 35. On the side of brake force simulation cylinder 32 facing away from connecting line 21, the cylinder is connected to low-pressure line 30 via a deactivation valve 36. Brake pressure simulation cylinder 32 may be locked with the aid of deactivation valve 36. When deactivation valve 36 is closed, piston 34 cannot be moved. When deactivation valve 36 is opened, the characteristic of the brake pedal with regard to pedal travel/pedal force may be adjusted with the aid of brake force simulation unit 31. For example, pressure sensor 27 may also be used to control/regulate brake force simulation unit 31. High-pressure line 20 is supplied by a pump 37 and a pressure storage 38 via a pressure build-up valve 39. Pump 37, which is connected to a motor 40 and is designed to be a triple-piston pump, for example, delivers hydraulic fluid from low-pressure line 30 in the direction of high-pressure line 20. If pressure storage 38 is not completely full when pump 37 is operating, a pressure builds up and is stored there. This occurs in particular when pressure build-up valve 39 is closed. The pressure of the fluid delivered by pump 37 and the pressure of pressure storage 38 are determined with the aid of a pressure sensor 41. Pump 37 and motor 40 may be regulated/controlled with the aid of pressure sensor 41 in such a way that the fluid pressure downstream from pump 37 and the fluid pressure in pressure storage 38 remain generally constant, at least as long as pressure build-up valve 39 is closed.

If pressure build-up valve 39 is opened, fluid may go through high-pressure line 20 into booster cylinder 8, so that brake cylinder 2 is actuated and the brake force is applied to the at least one wheel of the motor vehicle. A pressure reducing valve 42 is situated between high-pressure line 20 and low-pressure line 30. The pressure in high-pressure line 20 or in booster cylinder 8 is reducible via this pressure reducing valve, so that the brake force on the at least one wheel is reduced. The brake force is thus controllable and adjustable via pressure build-up valve 39 and pressure reducing valve 42.

A conventional ESP modulation system is preferably used as modulation unit 6. A conventional ABS modulation system or other brake pressure modulation systems may advantageously also be used. The pressure in booster cylinder 8 may be ascertained by estimation, but a pressure determination by a sensor system is also possible. Another pressure sensor may be provided for this purpose. Connecting valve 22 must be closed to build up a pressure in booster cylinder 8. After detection of the brake force with the aid of displacement sensor system 26 or pressure sensor 27, the driver's intent, i.e., the driver's braking intent, may be calculated or estimated. The pressure in booster cylinder 8 is adjusted with the aid of pressure build-up valve 39 and pressure reducing valve 22 based on the driver's braking intent.

Each of the valves shown in FIG. 1 has a fallback position, which is assumed in the event of an error in hydraulic system 19—for example, when the valves are currentless and cannot be triggered. Connecting valve 22 is opened in this state, deactivation valve 36 is closed, pressure build-up valve 39 and pressure reducing valve 42 are closed. In this way, the brake force may be hydraulically transferred from sensing cylinder 23 to booster cylinder 8 via connecting line 21. If this is also impossible, a mechanical connection 43 is additionally provided. A rod 44 connected to piston 28 has a ram 45, and a rod 46 connected to piston 10 has a ram 47. If the brake force cannot be transferred hydraulically from sensing cylinder 23 to booster cylinder 8 through connecting line 21, then ram 45 becomes connected to ram 47 at a certain deflection of piston 28, so that piston 10 and thus also piston 11 are mechanically deflected. Deactivation valve 36 is used to improve the volume balance in the fallback level—and in particular to improve the pedal sensation, i.e., providing brake force information for the driver—in this case. This allows shorter pedal travel for closed deactivation valve 36. However, it is also possible to omit deactivation valve 36 for cost reasons, for example, and to forgo the improvement in pedal sensation. An additional pressure sensor 50 may optionally be provided to determine the pressure prevailing in high-pressure line 20 or the pressure downstream from pressure build-up valve 39. Pressure sensor 50 may also be provided in the exemplary embodiments described below.

An alternative specific embodiment of brake system 1 shown in FIG. 1 is illustrated in FIG. 2. A decoupling valve 48 is provided as an additional element capable of decoupling pressure storage 38 from high-pressure line 20. This means that, with decoupling valve 48 closed, there is no longer a fluid connection from pressure storage 38 to pressure sensor 41, pump 37, and pressure build-up valve 39. The elasticity of pressure storage 38 may be disabled by closing decoupling valve 48. This means that the pressure in pressure storage 38 is not further increased by pump 37. In this way, pump 37 is able to build up elevated pressures in a very short period of time. These pressures may be conveyed to booster cylinder 8 via pressure build-up valve 39, and thus the brake cylinder is actuated for generating a high brake force. In this way, it is possible to build up very high brake forces in a short period of time, as may be necessary for functions for preventing a rollover of the motor vehicle, for example. The fallback position of the valves corresponds to that described with reference to FIG. 1. Decoupling valve 48 assumes an opened position, i.e., a fluid-flow position, in the event of an error.

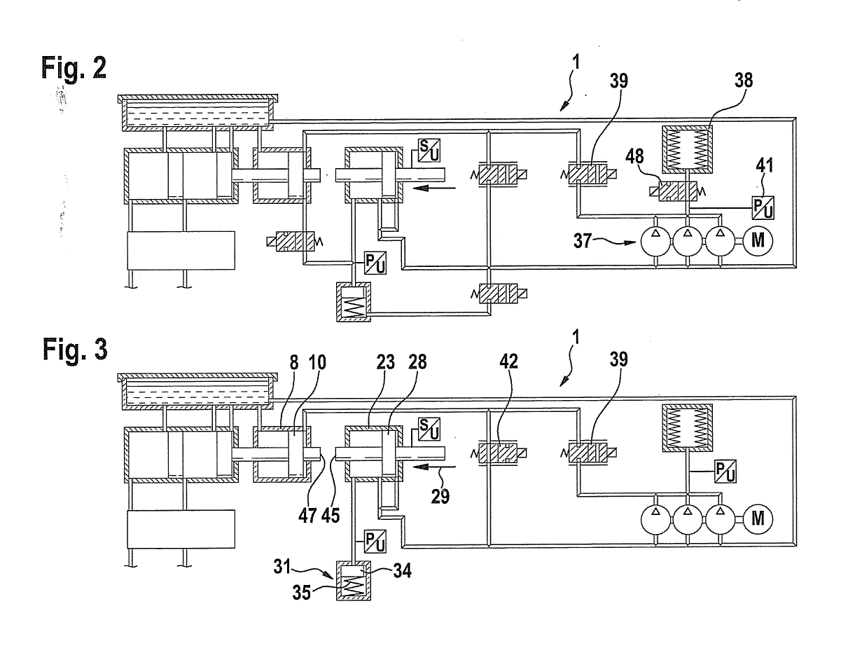

FIG. 3 shows another exemplary embodiment, in which connecting valve 22 and deactivation valve 36 are omitted in comparison with brake system 1 illustrated in FIG. 1. Due to the omission of connecting valve 22, the hydraulic connection between sensing cylinder 23 and booster cylinder 8 is also omitted. Sensor cylinder 23 and booster cylinder 8 are designed in such a way that, if a pressure cannot be built up in booster cylinder 8 via pressure build-up valve 39 and pressure reducing valve 42, the two pistons 10 and 28 come in contact mechanically via rams 45 and 47 after a defined free travel, and the pedal force (arrow 29) thus acts mechanically on brake cylinder 2.

Due to the omission of deactivation valve 36, brake force simulation unit 31 cannot be decoupled for this case. Pressure reducing valve 42 is therefore preferably designed as a currentless open valve, so the fallback position is the opened state. In contrast with the example illustrated in FIG. 1, the valve is opened in the event of an error. The force which must be applied by the driver of the motor vehicle to implement his braking intent is increased by the force which must be applied against piston 34 of brake force simulation unit 31, the piston being acted upon by spring 35. The advantage of this exemplary embodiment in comparison with that shown in FIG. 1 lies in the reduced number of components and the lower cost achievable thereby.

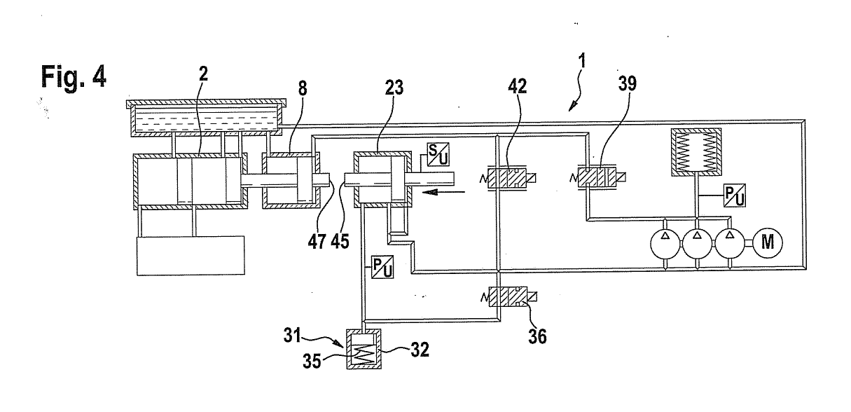

FIG. 4 shows an exemplary embodiment, which is characterized in comparison with that shown in FIG. 1 in that connecting valve 22 is omitted and deactivation valve 36 has a direct fluid connection with sensing cylinder 23. This means that deactivation valve 36 is connected on the same side of brake force simulation cylinder 32 as sensing cylinder 23. In this way, the hydraulic connection between sensing cylinder 23 and booster cylinder 8 is omitted. If no pressure may be built up in booster cylinder 8 via pressure build-up valve 39 and pressure reducing valve 42, then the mechanism described above with reference to FIG. 3 takes effect, namely that ram 45 comes into contact with ram 47 and thus actuates brake cylinder 2. As in FIG. 3, pressure reducing valve 42 and deactivation valve 36 are designed to be currentless open valves, whereas pressure build-up valve 39 is currentless closed. Due to the modified interconnection of brake force simulation cylinder 32, brake force simulation unit 31 may be decoupled for the case illustrated in FIG. 4. The pedal force, which the driver must apply to implement his braking intent, is therefore not increased by the force displacing the piston against spring 35 in brake force simulation cylinder 32. As is the case in FIG. 3, an advantage is obtained in the reduced number of components and the lower cost thereby achievable in comparison with the approach depicted in FIG. 1.

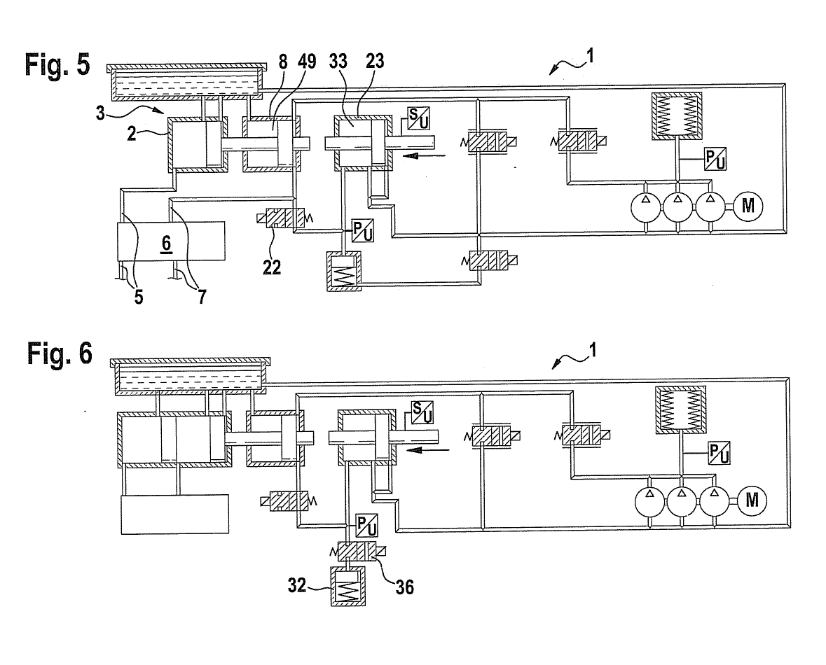

In the exemplary embodiment shown in FIG. 5, a brake cylinder 2 having only one circuit is used. Brake cylinder 2 thus has only first brake circuit 3, which is hydraulically connected to the front axle of the motor vehicle. For this purpose, brake cylinder 2 is connected to modulation unit 6 via brake line 5. Pressure from booster cylinder 8 is used via brake line 7 to apply the brake force to the wheels of the rear axle of the motor vehicle. Brake line 7 is therefore connected between booster cylinder 8 and connecting valve 22. Brake line 7, like brake line 5, also leads initially into modulation unit 6 and then to the brake devices of the wheels. The fallback position in the error case for the valves in FIG. 5 is the same as that in FIG. 1. On actuation of the brake pedal, i.e., brake setpoint detection means 24, volume is shifted from chamber 33 of sensing cylinder 23 into a chamber 49 of booster cylinder 8 and to the brake devices of the wheels on the rear axle. This is ensured because connecting valve 22 is opened. Brake force simulation cylinder 32 does not receive any volume because it is hydraulically supported on the secondary side by closed deactivation valve 36.

Error cases in which pressure cannot be built up even with the fallback positions of the valves described above, for example, in the event of leakage of brake force simulation cylinder 32, are also possible. For this case the combination of sensing cylinder 23 and booster cylinder 8 is designed in such a way that after a defined free travel, both pistons 44 and 46 are mechanically linked via rams 45 and 47 in the manner described above, and the pedal force thus acts mechanically on brake cylinder 2. Here again, the advantage in comparison with the approach depicted in FIG. 1 lies in the reduced number of components and the lower costs thereby achievable. Another advantage may be seen in the shorter overall length due to the omission of second brake circuit 4.

FIG. 6 shows another exemplary embodiment of brake system 1 from FIG. 1. Deactivation valve 36 here is situated upstream from the brake force simulation unit. The fallback position of the valves corresponds to that described with reference to FIG. 1. Due to this variant of brake system 1, costs may be reduced by omission of components.

1-18. (canceled)

19. A brake system for a motor vehicle, comprising:
an at least single-circuit brake cylinder using which a brake force may be applied to at least one wheel of the motor vehicle when actuated;
a booster cylinder, the brake cylinder being mechanically operatively connected to the booster cylinder, the booster cylinder being decoupled from a brake setpoint detector and being hydraulically triggerable for actuation of the brake cylinder according to a driver's intent, as detected with the aid of the brake setpoint detector.

20. The brake system as recited in claim 19, wherein the brake setpoint detector is a sensing cylinder operatively connected to at least one of a brake pedal, and a displacement sensor system which senses a deflection of a brake pedal.

21. The brake system as recited in claim 19, further comprising:
a hydraulic system which is provided for triggering the booster cylinder.

22. The brake system as recited in claim 21, wherein the hydraulic system includes at least one of a pump for generating a pressure, a pressure storage for storing the pressure, and a pressure sensor for determining the pressure.

23. The brake system as recited in claim 20, wherein the sensing cylinder is provided for feedback of brake force information generated by a brake force simulation unit to a driver.

24. The brake system as recited in claim 19, wherein a pressure build-up valve, which is switchable for building up a pressure in the booster cylinder, is provided between at least one of a pump and a pressure storage, and the booster cylinder.

25. The brake system as recited in claim 19, further comprising:
a pressure reducing valve which is switchable for reducing pressure in the booster cylinder.

26. The brake system as recited in claim 23, wherein the brake force simulation unit is a brake force simulation cylinder acted upon by a spring.

27. The brake system as recited in claim 26, wherein the brake force simulation unit has a deactivation valve for locking the brake force simulation unit.

28. The brake system as recited in claim 27, wherein the deactivation valve is operatively connected to the sensing cylinder directly or via the brake force simulation unit.

29. The brake system as recited in claim 21, wherein the hydraulic system includes a pressure equalizer.

30. The brake system as recited in claim 19, wherein the booster cylinder is at least one of hydraulically and mechanically coupled to the sensing cylinder.

31. The brake system as recited in claim 21, wherein the hydraulic system includes a pressure sensor operatively connected to a sensing cylinder.

32. The brake system as recited in claim 21, wherein the hydraulic system includes a pressure storage, the pressure storage including a decoupling valve for decoupling additional elements of the hydraulic system.

33. The brake system as recited in claim 21, wherein the brake cylinder is operatively connected to a brake device of the wheel.

34. The brake system as recited in claim 33, further comprising:
at least one of an ABS and ESP unit situated between the brake cylinder and the brake device.

35. The brake system as recited in claim 19, wherein the motor vehicle has one of a conventional drive or a hybrid drive.

36. A motor vehicle having a brake system, the brake system including:
an at least single-circuit brake cylinder using which a brake force may be applied to at least one wheel of the motor vehicle when actuated;
a booster cylinder, the brake cylinder being mechanically operatively connected to the booster cylinder, the booster cylinder being decoupled from a brake setpoint detector and being hydraulically triggerable for actuation of the brake cylinder according to a driver's intent, as detected with the aid of the brake setpoint detector.
